(19) United States
(12) Patent Application Publication
(10) Pub. No.: US 2015/0195650 A1
(43) Pub. Date: Jul. 9, 2015

(54) METHOD FOR AUDIO RECEIVER TO SELECT AUDIO SOURCE FROM MULTIPLE TRANSMITTERS

(71) Applicant: Flyover Innovations, LLC, Kansas City, MO (US)

(72) Inventor: MARK VOGT, Kansas City, MO (US)

(21) Appl. No.: 14/489,211

(22) Filed: Sep. 17, 2014

Related U.S. Application Data
(63) Continuation of application No. 13/964,012, filed on Aug. 9, 2013, now abandoned.

(51) Int. Cl. H04R 3/12

(52) U.S. Cl. CPC H04R 3/12

(57) ABSTRACT

A method for a wireless audio receiver connected to an audio system to select an audio source from multiple transmitter devices is provided. The method includes the said wireless audio receiver establishing a bidirectional communication connections with available transmitter devices; establishing a unidirectional audio streaming connection with a primary transmitter device to play on the said audio system, receiving an audio streaming connection request from an idle transmitter device; forwarding the said request to the said active transmitter device; forwarding a response received from said active transmitter to deny or accept audio transmission to the said requesting idle transmitter, disconnecting the existing audio streaming connection and establishing a new audio streaming connection with the said requesting transmitter in case of acceptance or lack of timely response from said previous active transmitter.

### CROSS REFERENCE TO RELATED APPLICATIONS

This application is a continuation application of and claims priority and the benefit of the filing date of U.S. patent application Ser. No. 13/964,012, filed Aug. 9, 2013, and titled “METHOD FOR AUDIO RECEIVER TO SELECT AUDIO SOURCE FROM MULTIPLE TRANSMITTERS”, the subject matter of which is hereby incorporated by reference in its entirety.

### BACKGROUND OF THE INVENTION

The present invention is generally related to remote control devices for controlling audio systems. More specifically, the present invention relates to using smart devices for remotely controlling and streaming music to audio systems.

In recent years, with the rapid development of electronic technology, more and more gadgets are being used leading to the presence of a multitude of remote control devices in our lives. Remote control devices are becoming more sophisticated with additional capabilities and features. This leads to added complexity in programming and operating these remote control devices.

Modern day handheld devices are also becoming increasingly powerful. Examples of these smart handheld devices include smart phones, music players, electronic tablets, etc. More specifically, these devices include iOS products like the iPhone™, iPod Touch™ and iPad™ devices (manufactured and sold by Apple Inc.), smart phones and tablets by Blackberry™, Android™ phones and tablets, and touch screen devices by Motorola, Samsung and others. These devices all include processors capable of performing multiple tasks and supporting many different “applications”. Some such applications enable these smart handheld devices to be used as remote control devices. With the increasing use of smart handheld devices as remote control devices, we are starting to face situations where there are multiple remote control devices for the same gadget. There is a need to for a system to determine the active remote control device. The present invention addresses such a need in audio systems.

### BRIEF SUMMARY OF THE INVENTION

The present invention discloses a request based control system to select an alternate audio source for said audio system. The use of smart handheld devices as remote control and transmitter devices includes pairing of smart handheld devices to establish bidirectional communication connections with a wireless audio receiver that is connected to an audio system. A unidirectional audio streaming connection between an active transmitter device and the said audio receiver is established. The invention involves the wireless audio receiver receiving an audio streaming request from an idle transmitter device; forwarding the said request to the active transmitter device; forwarding a response received from said active transmitter to deny or accept audio transmission to the said requesting idle transmitter, disconnecting the existing audio streaming connection and establishing a new audio streaming connection with the said requesting transmitter in case of acceptance or lack of timely response from said previous active transmitter.

### BRIEF DESCRIPTION OF THE DRAWINGS

FIG. 1 is a representative illustration of all the components in the invention.

FIG. 2 is a block diagram schematically representing the invention in the case of Android™ devices.

FIG. 3 is a block diagram schematically representing the invention in the case of iOS devices.

FIG. 4 is a block diagram schematically representing the invention in the case of both iOS devices and Android™ devices.

FIG. 5 is flowchart illustrating the audio source selection process.

Throughout the drawings it should be noted that like reference numbers are used to depict the same or similar elements, features and structures.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

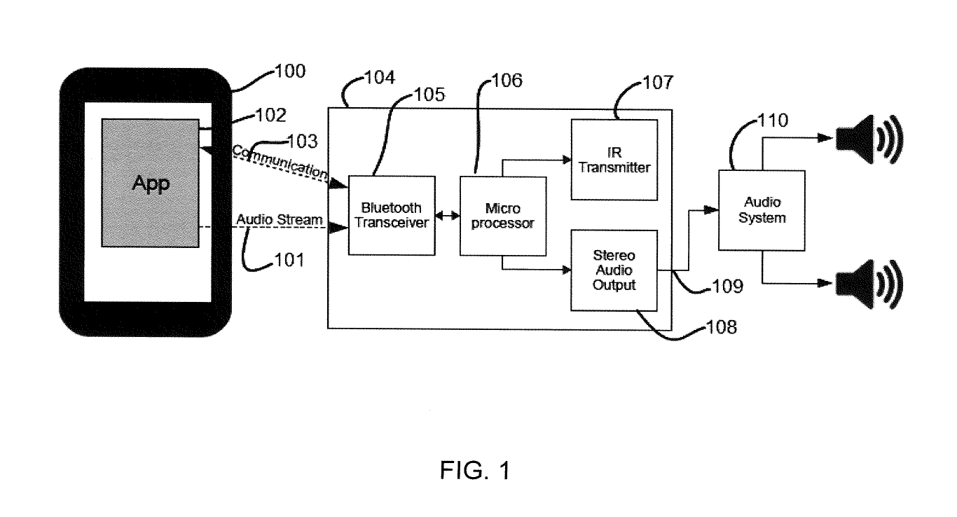

Referring now to FIG. 1, there is shown a representative illustration of all the main components in a preferred embodiment of the system. The system consists of a wireless audio receiver 104 connected to an audio system 110. Multiple smart handheld devices 100 can interface with the wireless audio receiver as remote control and audio streaming devices. The wireless audio receiver 104 consists of a wireless transceiver 105 connected to a processor 106 that controls all operations of the invention. The processor is connected to an IR transmitter 107 and is also connected to an audio amplifier 108 that is connected to a 3.5 mm headphone jack 109 to connect to the audio system 110 being controlled.

All of the configurations and choices concerning the operation of the system shown in FIG. 1, are handled with an easy-to-use graphic interface on the smart handheld device. A software application, commonly referred to as an “app,” is designed to run on smart handheld devices. The app 102 provides an easy, user-friendly graphic interface screens for users to indicate their control choices, to view status and to give and receive feedback from the wireless audio receiver. There are two modes of interface with the wireless audio receiver. One mode 103 is for bidirectional communication with the wireless audio receiver and the other 101 is for the audio streaming signal to be sent to the audio system 110. Variations in the app are available to conform the app to the requirements of the different smart handheld device platforms. Using the stored app 102, the smart handheld device 100 sends wireless signals to the processor 106. The processor 106 coordinates the signals coming from smart handheld device 100 in order to provide the control functions desired, and to provide overall coordination for invention. The processor 106 then sends the appropriate instructions to controlled device 110 based on the received commands from the smart handheld device 100.

In recent years, with the rapid development of electronic technology, smart handheld devices are now provided with a Bluetooth function supporting Bluetooth communication. The preferred embodiment of the invention uses Bluetooth communication for remote control and audio streaming.

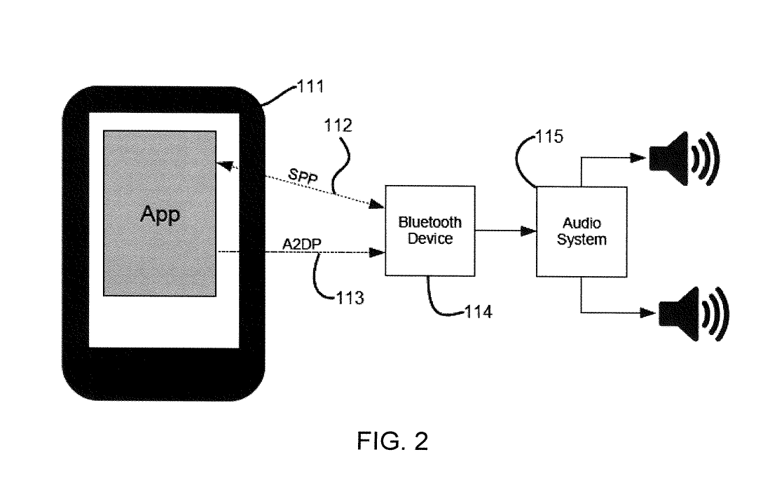

FIG. 2 shows a schematic representation of the system for Android™ smart handheld devices 111. The said disclosed system uses Bluetooth SPP profile 112 and A2DP 113 profile. SPP profile 112 is used for a bidirectional communication link between the wireless audio receiver 114 and the smart handheld device 111. SPP messages 112 include firmware updates, IR codes, and access requests. SPP can connect the wireless audio receiver to multiple smart handheld devices simultaneously. A2DP profile 113 is used to stream audio from the said smart handheld device 111. It is a unidirectional profile and allows only one smart handheld device 111 to be connected to the wireless audio receiver 114 at one time. The one device limitation of A2DP is why SPP is used to negotiate a transition to a new audio source.

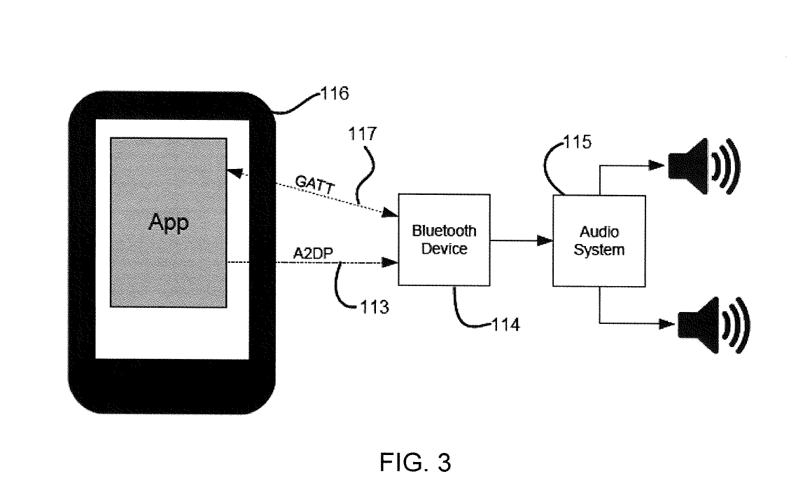

FIG. 3 shows a schematic representation of the system for iOS smart handheld devices 116. In this case, GATT profile 117 is used for the bidirectional messages instead of SPP. GATT is one of the core protocols of Bluetooth 4.0 Low Energy specification.

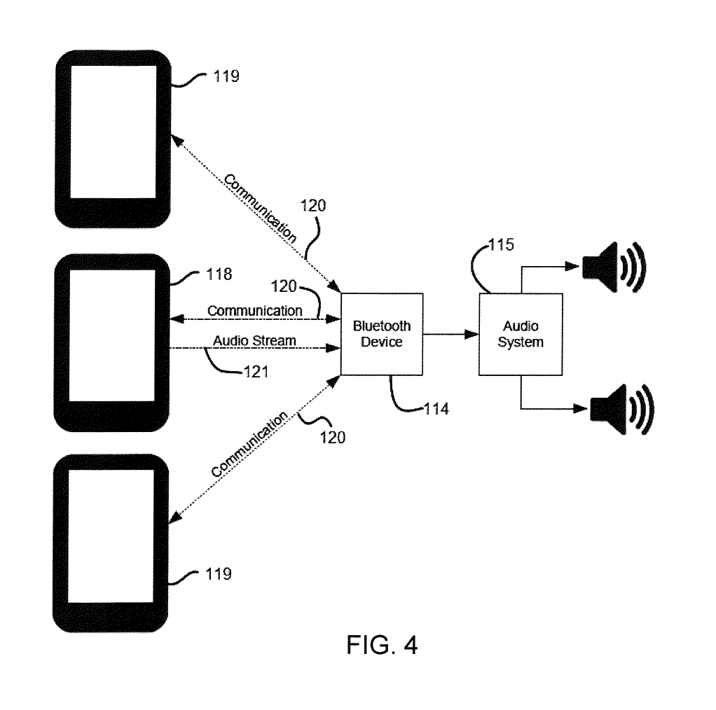

The invention allows for any number of simultaneous GATT (iOS) and SPP (Android™) connections with the wireless audio receiver, FIG. 4 is a schematic representation of a preferred embodiment showing simultaneous connections 120 for Android™ and iOS devices.

The GATT (iOS) and SPP (Android™) wireless communication technologies used in the preferred embodiment are representative of types of communication that may be applied. A wide variety of other wireless communication technologies may be applied in alternative embodiments.

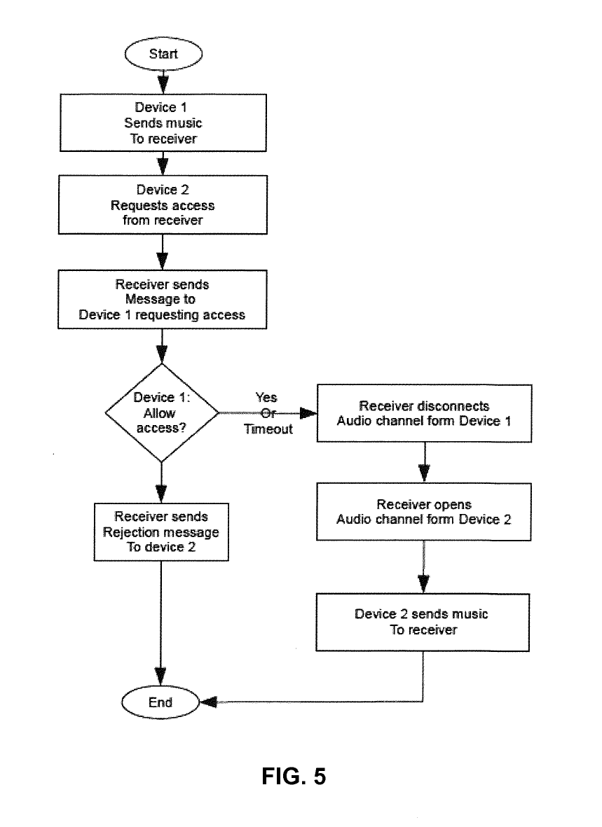

The invention allows for easily switching the remote control and audio streaming operation from one device to another by utilizing a setting feature in the app. When the setting is in auto mode, any requesting idle device is automatically accepted and connected to the wireless audio receiver. When the setting is in response mode, the control of the wireless audio receiver is as shown in FIG. 5.

FIG. 5 is a flowchart diagram of the invention illustrating the audio source selection process for the preferred embodiment shown in FIG. 4. In case of multiple smart handheld devices being used as remote control and audio streaming devices for the wireless audio receiver connected to an audio system, bidirectional communication 120 is established between all said smart devices and the said wireless audio receiver. Only one active smart handheld device 118 can establish an audio streaming connection 121 to the said wireless audio receiver 114 in order to stream music to the audio system 115. In order to stream audio through another “idle” smart handheld device 119, the said idle smart device 119 sends a request to stream audio to the said wireless audio receiver 114 which in turn forwards the request to the said active smart device 118. In case the said active smart device 118 denies the request, the said wireless audio receiver 114 sends a denial message to the requesting idle smart device 119 and the said active smart device 118 continues to stream music to the said wireless audio receiver 114 and finally to the audio system 115. In case the said active smart device 118 accepts the request or does not respond to the request in a timely manner, the acceptance is forwarded to the said idle smart device 119 through the said wireless audio receiver 114. The existing audio streaming connection is terminated and a new audio streaming connection is initiated between the requesting “newly activated” smart handheld device and the said wireless audio receiver.

What is claimed is:

1. A method for a wireless audio receiver connected to an audio system to select an audio source from multiple transmitter devices, said method comprising:
the wireless audio receiver establishing bidirectional communication connection with one or more transmitter devices;
the wireless audio receiver establishing a unidirectional audio streaming connection with one active transmitter device to play on the audio system;
the wireless audio receiver receiving an audio streaming connection request from a non-streaming idle transmitter;
the wireless audio receiver forwarding the audio streaming connection request from the idle transmitter to the active transmitter;
the wireless audio receiver receiving a timely response from said active transmitter;
the wireless audio receiver forwarding the response from said active transmitter to said idle transmitter; and
the wireless audio receiver disconnecting the existing audio streaming connection and establishing a new audio streaming connection with said idle transmitter or continuing with the existing audio streaming connection based on response from the said active transmitter.

2. A method of claim 1 wherein Bluetooth protocol is used for wireless communication between the wireless audio receiver and transmitter devices.

3. A method of claim 1 wherein Wi-Fi protocol is used for wireless communication between the wireless audio receiver and transmitter devices.

4. A method of claim 1 wherein the transmitter devices are any combination of iOS, Android™, Blackberry™ and Windows smart handheld devices.

5. A method for a wireless audio receiver connected to an audio system to select an audio source from multiple transmitter devices, said method comprising:
the wireless audio receiver establishing bidirectional communication connection with one or more transmitter devices;
the wireless audio receiver establishing a unidirectional audio streaming connection with one active transmitter device to play on the audio system;
the wireless audio receiver receiving an audio streaming connection request from any non-streaming idle transmitter;
the wireless audio receiver forwarding the audio streaming connection request from said idle transmitter to said active transmitter;
the wireless audio receiver not receiving a timely response from said active transmitter;
the wireless audio receiver sending an accepting response to said idle transmitter; and
the wireless audio receiver disconnecting the existing audio streaming connection with said active transmitter and establishing a new audio streaming connection with said idle transmitter.

6. A method of claim 5 wherein Bluetooth protocol is used for wireless communication between the wireless audio receiver and transmitter devices.

7. A method of claim 5 wherein Wi-Fi protocol is used for wireless communication between the wireless audio receiver and transmitter devices.

8. A method of claim 5 wherein the transmitter devices are any combination of iOS, Android™, Blackberry™ and Windows smart handheld devices
